(19) United States
(12) Patent Application Publication
(10) Pub. No.: US 2026/0349136 A1
(43) Pub. Date: Nov. 5, 2026

(54) METHOD FOR ESTIMATING NET INELASTIC GAMMA RAY COUNTS

(71) Applicant: SCHLUMBERGER TECHNOLOGY CORPORATION, Sugar Land, TX (US)

(72) Inventor: Marie-Laure MAUBORGNE, Clamart (FR)

(21) Appl. No.: 19/116,396

(22) PCT Filed: Sep. 25, 2023
(86) PCT No.: PCT/US2023/075037

§ 371 Date: Mar. 28, 2025

Related U.S. Application Data
(60) Provisional application No. 63/378,273, filed on Oct. 4, 2022.

(51) Int. Cl. G01V 5/10

(52) U.S. Cl. CPC G01V 5/108

(57) ABSTRACT

A method for estimating net inelastic gamma ray counts includes acquiring a burst gamma ray count measured during a neutron burst time interval, acquiring a capture gamma ray count measured during at least one neutron capture time interval, acquiring a neutron count during at least the neutron burst time interval, and subtracting a portion of the capture gamma ray count and a portion of the neutron count from the burst gamma ray count to estimate the net inelastic gamma ray count.

### CROSS REFERENCE TO RELATED APPLICATIONS

This application claims the benefit of U.S. Provisional Application No. 63/378,273, entitled “METHOD FOR ESTIMATING NET INELASTIC GAMMA RAY COUNTS,” filed Oct. 4, 2022, the disclosure of which is hereby incorporated herein by reference.

### BACKGROUND

Density logging measurements have been used in the oilfield industry for many decades. These measurements traditionally make use of a ¹³⁷Cs gamma ray source to emit gamma rays into the wellbore. The emitted gamma rays scatter back to the tool, where they are detected and processed to estimate formation density. In more recent years, some density logging tools have replaced the ¹³⁷Cs gamma ray source with a neutron source, such as a pulsed neutron generator (PNG). During a logging operation, emitted neutrons induce inelastic gamma rays in the wellbore (via inelastic scattering events), which scatter back to the tool where they are detected and processed (e.g., via an inversion or other algorithm) to estimate the formation density.

As is known to those of ordinary skill in the art, neutron interactions with formation and other nuclei are commonly separated according to the energy of the neutron. After a high 1 energy neutron (e.g., 14.1 MeV) has been emitted by a source, it begins to lose energy by the processes of inelastic and elastic scattering. Inelastic scattering events are generally produced at neutron energies above 1-2 MeV. In inelastic interactions, kinetic energy lost by the neutron excites the nucleus, which may in turn emit characteristic “inelastic” gamma rays upon de-excitation. In neutron based density logging tools these inelastic gamma rays may be the gamma ray source used for the formation density measurement. Determination of an accurate inelastic gamma ray count rate may therefore be an important consideration in determining the formation density. In elastic interactions, kinetic energy is transferred from the neutron to the nucleus without a corresponding gamma ray emission. As the neutrons approach thermal energies (e.g., less than about 0.05 eV) they are generally absorbed by nuclei in the target, producing excited isotopes that emit characteristic “capture” gamma rays upon de-excitation.

Inelastic interaction events and capture interaction events theoretically happen at different times (such that the inelastic gamma rays and the capture gamma rays are emitted at distinct times). The decrease in neutron energy from 14 MeV to 1 MeV is very rapid, e.g., occurring in less than 1 microsecond. Capture events generally occur much later, e.g., tens or hundreds of microseconds after the neutron leaves the source. However, in practical logging applications, neutrons may be emitted from a neutron source in a sequence of short bursts. It will therefore be appreciated that in practice inelastic gamma rays and capture gamma-rays can (and generally do) overlap in time therefore making it difficult to distinguish one from the other. Various techniques are known for estimating inelastic and capture gamma ray counts. For example, a portion of the gamma ray signal measured during a time interval between bursts can be subtracted from the gamma ray signal received during a burst. While this approach has been serviceable, there is room for further improvement.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a disclosed nuclear logging tool.

FIG. 2 schematically depicts one example embodiment of the nuclear logging tool shown on FIG. 1.

FIG. 3 depicts one example PNG timing sequence that may be used by a pulsed neutron source to generate high energy neutrons (e.g., bursts of 14 MeV neutrons).

FIG. 4 depicts example plots of gamma ray count rates versus formation density.

FIG. 5 depicts an example plot of a modelled neutron count rate versus formation density.

FIGS. 6A and 6B (collectively FIG. 6) depict flow charts of example method embodiments disclosed herein.

FIGS. 7A and 7B (collectively FIG. 7) depict plots of computed net inelastic gamma ray count rates versus modeled net inelastic gamma ray count rates.

### DETAILED DESCRIPTION

Embodiments of this disclosure include systems and methods for estimating a net inelastic gamma ray count. One example method includes acquiring a burst gamma ray count measured during a neutron burst time interval, acquiring a capture gamma ray count measured during at least one neutron capture time interval, acquiring a neutron count during at least the neutron burst time interval, and subtracting a portion of the capture gamma ray count and a portion of the neutron count from the burst gamma ray count to estimate the net inelastic gamma ray count. The method may further include processing the net inelastic gamma ray count to estimate a formation density.

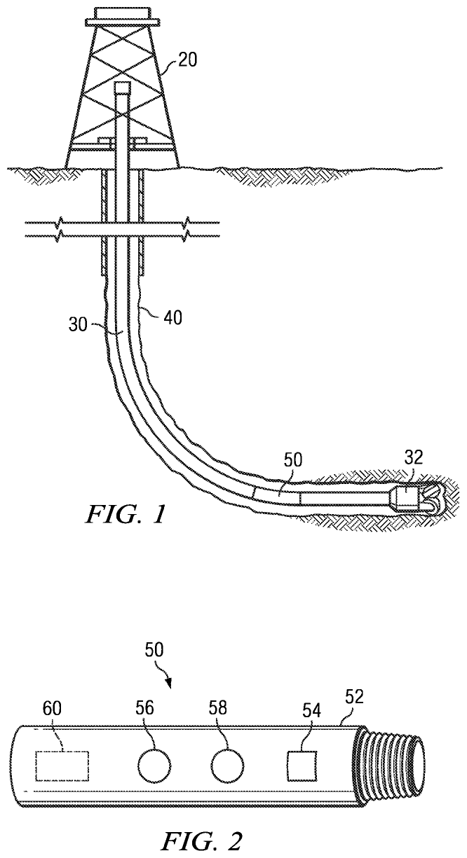

FIG. 1 depicts an oil or gas drilling rig 20 including an example nuclear logging tool 50 (such as a neutron based density logging tool). In the depicted embodiment, a land rig 20 is positioned over an oil or gas formation (not shown). The rig may include a derrick and a hoisting apparatus (not shown) for raising and lowering a drill string 30, which, as shown, extends into borehole 40 and includes a drill bit 32 deployed at the lower end of a bottom hole assembly (BHA). The BHA further includes the example logging tool 50.

It will be understood that the deployment illustrated on FIG. 1 is merely an example. Drill string 30 may include substantially any suitable downhole tool components, for example, including a steering tool such as a rotary steerable tool, a downhole telemetry system, and one or more additional MWD and/or LWD tools including various sensors for sensing downhole characteristics of the borehole and the surrounding formation. The disclosed embodiments are by no means limited to any particular drill string configuration.

It will be further understood that the disclosed embodiments are not limited to use with a land rig, but are equally well suited for use with either onshore or offshore subterranean operations. Moreover, disclosed embodiments are not limited to logging while drilling embodiments as illustrated on FIG. 1. The disclosed embodiments are equally well suited for use with any nuclear logging tool, including wireline logging tools and slickline logging tools.

FIG. 2 schematically depicts one example embodiment of nuclear logging tool 50. The tool 50 includes a neutron source 54 deployed in a tool collar 52 (or an internal mandrel). The tool collar 52 and optional internal mandrel may be referred to collectively herein as a tool body. The neutron source 54 may advantageously include a pulsed neutron generator (PNG) including an electrical source that makes use of, for example, a deuterium-tritium (D-T) nuclear reaction and/or a tritium-tritium (T-T) nuclear reaction. Such PNGs are commonly used in the industry. Logging tool 50 further includes a gamma ray detector 56 deployed in the tool collar 52, for example, axially offset from the neutron source as depicted. The gamma ray detector 54 may include substantially any suitable gamma ray detector, for example, including a sodium iodide (Nal) scintillator crystal and a photomultiplier. Such gamma ray detectors are also commonly used in the industry. Logging tool 50 further includes a neutron detector 58 deployed in the tool collar 52, for example, axially between the neutron source 54 and the gamma ray detector 56 as depicted. The neutron detector 58 may include substantially any suitable neutron detector or detectors, for example, including a thermal neutron detector, an epithermal neutron detector, and/or a fast neutron detector. For example, the neutron detector 58 may include a conventional ³He proportional counter. In certain advantageous embodiments, the neutron detector may include a thermal neutron detector or a detector that is sensitive to both thermal and epithermal neutrons. Such detectors commonly provide higher count rates and therefore better statistics and signal to noise. Notwithstanding, the disclosed embodiments are not limited in this regard.

With continued reference to FIG. 2, it will be understood that the disclosed embodiments are not limited to tool embodiments including axially spaced gamma ray and neutron detectors as depicted. For example, the gamma ray and neutron detectors may be deployed at the same axial location on the tool 50. Moreover, the disclosed embodiments are not limited to tool embodiments including distinct gamma ray and neutron detectors. In certain embodiments a combined detector may be employed that is sensitive to both neutrons and gamma rays, such as an elpasolite (e.g., Cs₂LiYCl₆) scintillator coupled to a photosensor. In such detectors, the shape of a neutron induced light pulse may be different from the shape of a gamma ray induced light pulse thereby making it possible to distinguish and separately count neutrons and gamma rays.

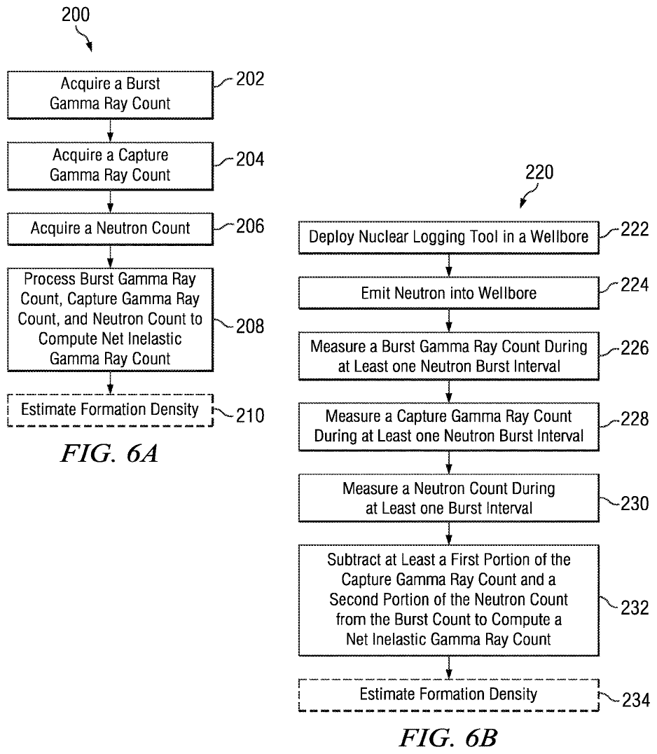

With continued reference to FIG. 2, logging tool 50 may further include an electronic controller 60 including one or more processors (e.g., microprocessors) and electronic memory. The controller 60 may include processor executable instructions (e.g., stored in memory) configured to cause the neutron source 54 (e.g., a PNG) to emit neutrons in a predetermined emission sequence (e.g., in pulses having a predetermined pulse lengths and pulse intervals). The controller may be further configured to receive electrical/electronic signals from the gamma ray detector 55 and to process the signals to generate gamma ray counts. The controller 60 may be still further configured to receive electrical/electronic signals from the neutron detector 58 and to process the signals to generate neutron counts. The controller 60 may include processor executable instructions configured to execute the disclosed methods steps described in more detail below (e.g., with respect to FIGS. 6A and 6B), for example, to determine an inelastic gamma ray count via subtracting a portion of a detected neutron count from a detected gamma ray count. The controller may be still further configured to process the inelastic gamma ray count to estimate a formation density. It will, of course, be understood that the disclosed embodiments are not limited to the use of or the configuration of any particular controller hardware, firmware, and/or software.

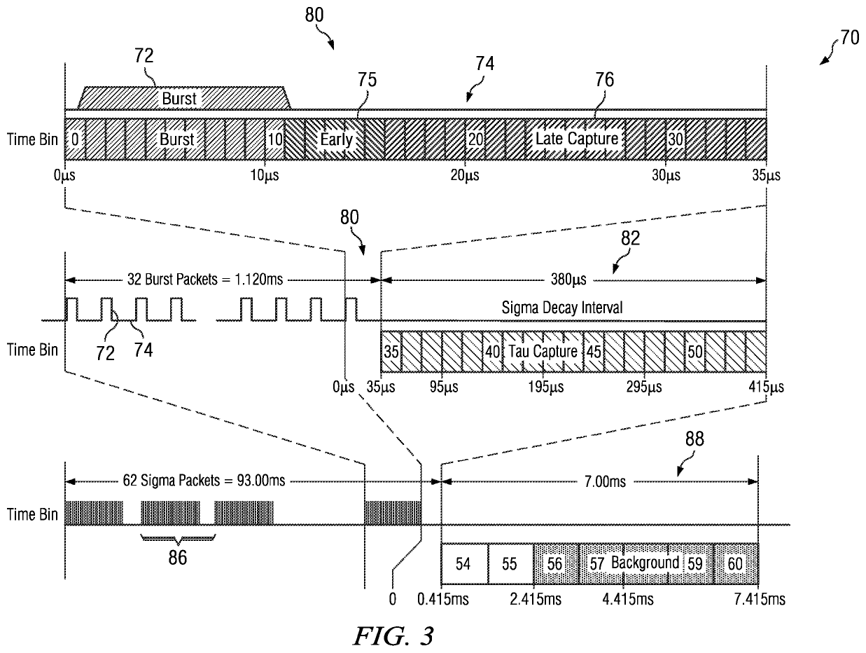

FIG. 3 depicts one example PNG timing sequence 70 that may be used by neutron source 54 to generate high energy neutrons (e.g., bursts of 14 MeV neutrons). The depicted example timing sequence includes a series of short duration neutron bursts 72 (e.g., each burst being 10 microseconds in duration). Each burst 72 may be followed by a corresponding short capture interval 74 in which no neutrons are generated (e.g., a 25-microsecond duration). Moreover, as depicted, the capture interval 74 may be divided into early 75 and late 76 capture intervals, for example, having corresponding durations of 5 microseconds and 20 microseconds. This burst packet sequence 80 (the sequence of neutron bursts 72 and capture intervals 74) may be repeated substantially any suitable number of times, for example, 32 times in the depicted example, and may then be followed by a longer capture interval 82 (e.g., a sigma decay interval having a duration of 380 microseconds). This sigma packet sequence 86 (the repeated burst packet sequences 80 and the sigma decay 82) may also be repeated substantially any suitable number of times, for example, 62 times in the depicted example, and may then be followed by a still longer capture interval or background interval 88 (e.g., having a duration of 7 milliseconds). In this example, the duration of the PNG timing sequence 70 is 100 milliseconds. It will be appreciated that the depicted PNG timing sequence 70 may be repeated substantially any number of times during a logging operation (e.g., at 100 millisecond intervals). Moreover, those of ordinary skill in the art will readily appreciate that PNG timing sequence 70 is merely an example. The disclosed embodiments are in no way limited to any particular PNG timing sequence configuration.

During a logging operation, high energy neutrons (e.g., 14 MeV) may be emitted during the neutron burst portion of a PNG timing sequence (e.g., during bursts 72 in FIG. 3). The emitted neutrons lose energy via inelastic and elastic scattering with nuclei in the surrounding environment. Inelastic scattering events (and the corresponding emission of inelastic gamma rays) generally occur within about 1 microsecond of neutron emission as the neutron energy decreases from 14 MeV to about 1 MeV. Neutron capture events (and the corresponding emission of capture gamma rays) generally occur much later than the inelastic scattering events (within the life of a single neutron), e.g., tens or hundreds of microseconds after neutron emission.

However, as noted above, in practical logging applications, neutrons are emitted from a neutron source in a sequence of short bursts and capture intervals. Inelastic gamma rays may be generated during the neutron burst (e.g., within 1 microsecond of neutron generation). Capture gamma rays may be generated during later neutron bursts or capture intervals (e.g., tens or hundreds of microseconds after neutron generation). As a result, the emission of inelastic gamma rays and capture gamma rays commonly overlap in time. In particular, inelastic gamma rays and capture gamma rays may be detected during neutron bursts. Inelastic gamma rays are generally not detected during the various capture intervals such that primarily capture gamma rays may be detected during these intervals (during which no neutrons are generated).

During common nuclear (e.g., density) logging operations, gamma rays may be accumulated during the neutron bursts as well as during one or more of or some combination of the capture intervals to generate burst counts and capture counts. Inelastic gamma ray counts (or a count rate depending on the operational objectives) is commonly obtained via subtracting measured capture gamma rays (or some fraction or multiple of the capture gamma rays) from the burst gamma rays, for example, as follows:

Iₙₑₜ=B−α·C (1)

where Iₙₑₜ represents the net inelastic gamma ray count, B represents a measured burst interval gamma ray count, C represents a measured capture interval gamma ray count, and a represents a fractional coefficient that may depend on the acquisition time, dead time, and the particular capture intervals used to measure the capture gamma rays, and other factors, such as the borehole and formation thermal neutron capture cross sections (Sigma), as well as the epithermal neutron slowing down time (the time for epithermal neutrons to slow down to thermal energy), and/or other indicators of the thermal and epithermal neutron flux. It will be appreciated that α may be a constant value or change as a function of the borehole and formation environment during the logging operation. It will be further appreciated that while not shown in Eq. (1), background gamma rays (e.g., activation and natural gamma rays) may also be subtracted. The contribution of theses background gamma rays is generally comparatively very small and is therefore neglected in Eq. (1).

While the above-described method of obtaining net inelastic gamma ray counts has been used in commercial logging operations (e.g., in density logging measurements), there is room for further improvements. For example, observed net inelastic gamma ray count rates sometimes do not match modelled count rates (e.g., obtained via Monte Carlo simulations). In particular, at high formation densities (e.g., above about 2.4g/cm³ ), experimental net inelastic gamma ray count rates may significantly exceed the inelastic gamma ray count rates estimated from via Monte Carlo simulations.

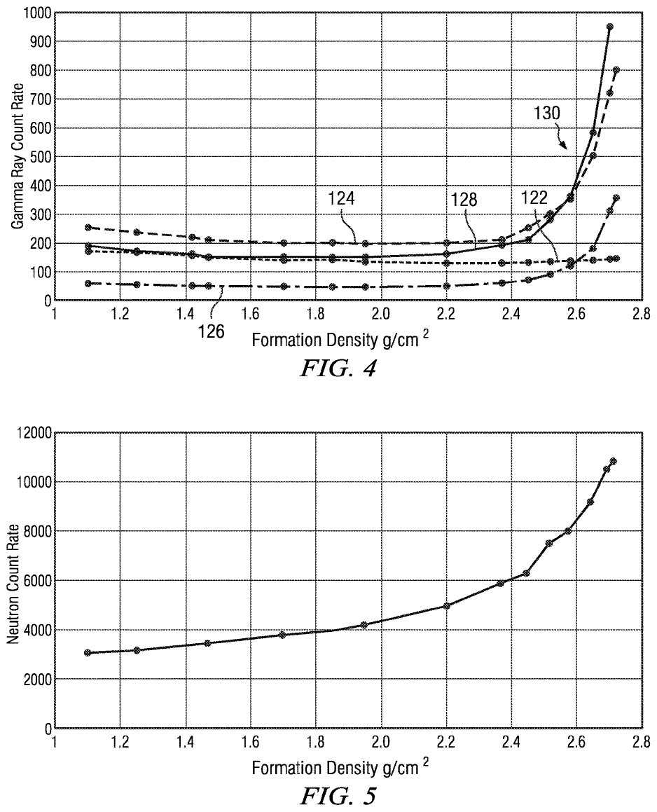

FIG. 4 depicts example plots 120 of gamma ray count rates in units of counts per second versus formation density. Example modelled inelastic gamma ray count rates are plotted at 122. Note that in the depicted example the modelled inelastic gamma ray count rate is not strongly influenced by formation density and monotonically decreases from a high of about 170 at a formation density of 1.1 to a low of about 130 at a formation density of 2.2 before monotonically increasing to about 145 at a formation density 2.7. Example measured burst count rates (acquired during the bursts 72 in FIG. 3) are plotted at 124. Example measured early and late capture count rates (acquired during the early and late capture intervals 75 and 76 in FIG. 3) are plotted at 126 and 128.

With continued reference to FIG. 4, note that the relationship between the measured burst and capture gamma ray count rates 124, 126, and 128 and formation density is similar to that of the modelled inelastic gamma ray count rate at low formation densities (e.g., less than about 2.4). However, at higher formation densities (e.g., greater than about 2.4), the measured burst and capture gamma ray count rates 124, 126, and 128 increase exponentially with increasing formation density as depicted generally at 130. As a result, it is difficult to accurately reproduce the modelled inelastic gamma ray count rate (e.g., plot 122) using a linear combination of the burst count rate (e.g., plot 124) and one or more capture count rates (e.g., plots 126 and 128), for example, as given in Eq. (1). When the coefficient(s) of the capture count rate(s) is/are selected to accurately reproduce the modelled inelastic gamma ray count rate at low formation densities, then a poor reproduction is achieved at high formation 11 densities. Likewise, when the coefficient(s) is/are selected to accurately reproduce the modelled inelastic gamma ray count rate at high formation densities, then a poor reproduction is achieved at low formation densities.

One aspect of the disclosed embodiments was the realization that the measured and modelled neutron count rate shows a similar increase with increasing formation density. FIG. 5 depicts an example plot of a modelled neutron count rate (thermal and epithermal) versus formation density. Note that the depicted neutron count rate increases with increasing formation density, particularly at formation densities above about 2.4 where the count rate increases rapidly with increasing density. A further realization of the disclosed embodiments was that the modelled inelastic gamma ray count rate may be better reproduced by subtracting both capture gamma rays and measured neutrons from the burst gamma rays or gamma ray count rate. For example, it was realized that the modelled inelastic gamma ray count rate may be better reproduced by subtracting both a portion of the capture gamma rays obtained in at least one capture interval and a portion or a mathematical function of the measured neutrons from the burst gamma rays.

Turning now to FIGS. 6A and 6B (collectively FIG. 6), flow charts of example method embodiments 200 and 220 for estimating net inelastic gamma ray counts are depicted. It will be understood that by gamma ray count it is meant a gamma ray count (a number of gamma rays) and/or a gamma ray count rate (a number of gamma rays per unit time). In FIG. 6A, method 200 includes acquiring a burst gamma ray count at 202 and acquiring a capture gamma ray count at 204. A neutron count is also acquired at 206. The acquired burst gamma ray count, capture gamma ray count, and neutron count are then processed at 208 to estimate a net inelastic gamma ray count. Method 200 may further optionally include processing the net inelastic gamma ray count (or count rate) to estimate a formation density at 210. The formation density may be estimated, for example, as disclosed in U.S. Pat. Nos. 5,608,215 and 5,804,820.

With continued reference to FIG. 6A, the net inelastic gamma ray count may be estimated at 208, for example, by subtracting a portion of the capture gamma ray count and a portion of the neutron count from the burst gamma ray count to estimate the net inelastic gamma ray count. In another example, the processing at 208 may include subtracting a function of the acquired neutrons, such as a logarithmic function or a polynomial function of the acquired neutrons from the burst gamma rays. The processing at 208 may be expressed mathematically, for example, according to one of the following equations:

Iₙₑₜ=B−α·C−γ·N (2)

Iₙₑₜ=B−α₁·C₁−α₂·C₂−γ·N (3)

where Iₙₑₜ represents the net inelastic gamma ray count, B represents an acquired burst gamma ray count, C represents an acquired capture interval gamma ray count, and N represents an acquired neutron count. In Eq. (3) C₁ and C₂ represent capture interval gamma ray counts acquired in corresponding to first and second distinct or overlapping capture intervals such as the early and late capture intervals 75 and 76 described above with respect to FIG. 3. The coefficients α, α₁, α₂, and γ may be fractions (the same or different) having values less than 1 and may be related to various operational parameters such as acquisition time, dead time, and the particular capture intervals as well other factors, such as the borehole and formation thermal neutron capture cross sections (as noted above with respect to Eq. (1)). Moreover, as stated above, the processing may include subtracting a function of the acquired neutrons, for example, as follows:

Iₙₑₜ=B−α·C−ƒ(N) (4)

Iₙₑₜ=B−αa₁·C₁−α₂·C₂−ƒ(N) (5)

where ƒ(N) represents a function of the acquired neutron count such as a logarithmic function or a polynomial function of the acquired neutron count. In such an embodiment, the acquired neutron count is first processed according to the function (e.g., by taking a logarithm of the neutron count) to get a corresponding functional neutron quantity. The functional neutron quantity is then subtracted, for example, as shown in Eqs. (4) and (5). It will be appreciated that ƒ(N) is generally less than N such that the functional neutron quantity represents a portion of the measured neutron count. Moreover, while not shown in Eqs. (2)-(5), it will be understood that B may also be multiplied by a corresponding fractional coefficient such that the following quantities are subtracted from the burst count B or a fraction (or portion) thereof. The disclosed embodiments are not limited in this regard.

In FIG. 6B, method 220 includes deploying a logging tool, such as logging tool 50 (FIG. 2), in a wellbore penetrating a subterranean formation at 222. In certain advantageous embodiments, the logging tool may include a PNG neutron source, a gamma ray detector, and a neutron detector as described above. The neutron source, such as a PNG, emits neutrons into the wellbore at 224. The neutrons may be emitted in a series of neutron burst intervals, each of which is followed by a corresponding capture interval as described above with respect to FIG. 3. The emitted neutrons generally cause gamma rays to be emitted by various nuclei in the wellbore environment. Burst gamma rays (gamma ray counts) may be measured using the gamma ray detector during one or more of the burst intervals at 226 while capture gamma rays (gamma ray counts) may be measured using the gamma ray detector during one or more of the capture intervals at 228. For example, the measured burst and capture gamma rays may include total burst and capture gamma ray counts or burst and capture gamma ray count rates (e.g., counts per second or per minute). These different measurements are referred to herein collectively as gamma ray counts. Neutrons (neutron counts) may be measured during at least one of the burst intervals using a neutron detector at 230. The acquired neutrons may include substantially any detected neutrons, for example, including thermal, epithermal, and/or fast neutrons. In certain advantageous embodiments, the acquired neutrons may include at least thermal neutrons. By neutron count it is also meant a neutron count rate. The acquired burst gamma ray count, capture gamma ray count(s), and neutron count are then processed at 232 to estimate a net inelastic gamma ray count, for example, as described above with respect to FIG. 6A and Eqs. (2), (3), (4), and (5). Method 220 may further optionally include processing the net inelastic gamma ray count (or count rate) to estimate a formation density at 234. It will be appreciated that the processing may be conducted by a downhole processor deployed in the logging tool in real-time while logging or during processing of the data after the completion of the logging operation. The disclosed embodiments are not limited in this regard.

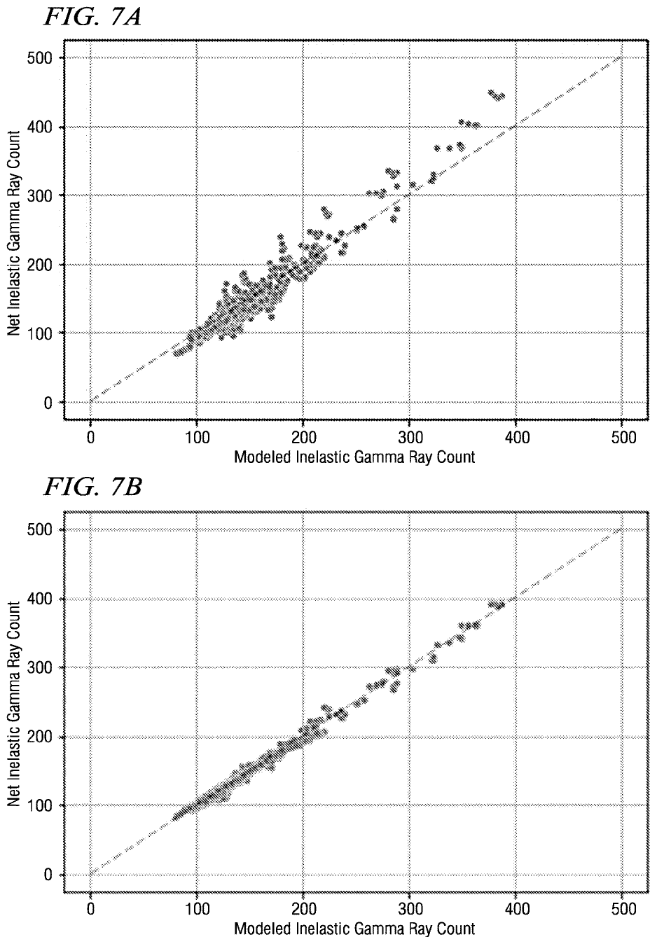

FIGS. 7A and 7B (collectively FIG. 7) depict plots of a computed net inelastic gamma ray count rate on the vertical axis versus a modelled net inelastic gamma ray count rate on the horizontal axis obtained using a Monte Carlo simulation. The individual data points in the plots represent measurements made in a range of environments and lithologies, including anhydrite, dolomite, lignite, limestone, plaster, sandstone, shale, water, and diesel. In FIG. 7A, the net inelastic gamma ray count rate was computed by subtracting a portion of the capture gamma ray count rate plotted on the vertical axis from the burst gamma ray count rate as in Eq. (1). Note that the computed net inelastic gamma ray count rate showed significant scatter about the modelled gamma ray count rate at low count rates (e.g., less than about 300 in this example) and deviated from the modelled count rate at higher count rates. In FIG. 7B, the net inelastic gamma ray count rate on the vertical axis was computed by subtracting a portion of the capture gamma ray count rate and a portion of a function of the neutron count rate from the burst gamma ray count rate as in Eq. (5). Note the excellent agreement between the computed and modelled net inelastic gamma ray count rates over the full range of count rates and lithologies. In this particular example, ƒ(N) in Eq. (5) was 33 log(N)+235. It will be appreciated that a polynomial function (such as a second, third, or fourth order polynomial) giving similar functional neutron quantities over the depicted range of neutron count rates could have been utilized to obtain the same result.

With continued reference to FIG. 7B, it will be appreciated that the coefficients in Eqs. (2), (3), (4), and/or (5) may be determined, for example, via fitting a set of corrected data with Monte Carlo model net inelastic gamma ray count rate predictions. For example, the data may include burst gamma ray count rates, capture gamma ray count rates, and neutron count rates in a number of different formations having a range of densities. The data may be iteratively processed using the correction model (one or more of Eqs. (2), (3), (4), and (5)) to obtain corresponding net inelastic gamma ray count rates. The coefficients may be selected, for example, based on a least square best fit of the set of corrected data with the Monte Carlo simulation.

It will be understood that the present disclosure includes numerous embodiments. These embodiments include, but are not limited to, the following embodiments.

In a first embodiment, a method for estimating a net inelastic gamma ray count comprises: acquiring a burst gamma ray count measured during a neutron burst time interval; acquiring a capture gamma ray count measured during at least one neutron capture time interval; acquiring a neutron count during at least the neutron burst time interval; and subtracting a portion of the capture gamma ray count and a portion of the neutron count from the burst gamma ray count to estimate the net inelastic gamma ray count.

A second embodiment may include the first embodiment, further comprising: deploying a logging tool in a subterranean wellbore, the logging tool including a pulsed neutron generator (PNG), a gamma ray detector, and a neutron detector; and causing the PNG to emit neutrons into the subterranean wellbore during the neutron burst time interval.

A third embodiment may include the second embodiment, wherein the acquiring the burst gamma ray count comprises causing the gamma ray detector to accumulate gamma rays during the neutron burst time interval; the acquiring the capture gamma ray count comprises causing the gamma ray detector to accumulate gamma rays during the at least one neutron capture time interval; and the acquiring the neutron count comprises causing the neutron detector to accumulate neutrons during at least the neutron burst time interval.

A fourth embodiment may include the third embodiment, wherein the acquiring the neutron count comprises causing the neutron detector to accumulate neutrons during both the neutron burst time interval and one or more of the at least one neutron capture time interval.

A fifth embodiment may include any one of the first through the fourth embodiments, wherein the acquired burst gamma ray count comprises a burst gamma ray count rate; the acquired capture gamma ray count comprises a capture gamma ray count rate; and the acquired neutron count comprises a neutron count rate.

A sixth embodiment may include any one of the first through the fifth embodiments, wherein the acquiring the burst gamma ray count comprises acquiring the burst gamma ray count during a plurality of neutron burst time intervals; the acquiring the capture gamma ray count comprises acquiring the capture gamma ray count during a plurality of neutron capture time intervals; and the acquiring the neutron count comprises acquiring the neutron count during the plurality of neutron burst intervals and the plurality of neutron capture intervals.

A seventh embodiment may include any one of the first through the sixth embodiments, wherein the acquired neutron count comprises at least thermal neutrons.

An eighth embodiment may include any one of the first through the seventh embodiments, wherein the subtracting further comprises: multiplying the capture gamma ray count by a first coefficient to compute the portion of the capture gamma ray count; multiplying the neutron count by a second coefficient to compute the portion of the neutron count; and subtracting the portion of the capture gamma ray count and the portion of the neutron count from the burst gamma ray count to estimate the net inelastic gamma ray count.

A ninth embodiment may include any one of the first through the eighth embodiments, wherein the subtracting further comprises: multiplying the capture gamma ray count by a first coefficient to compute the portion of the capture gamma ray count; processing the neutron count with a function to compute the portion of the neutron count; and subtracting the portion of the capture gamma ray count and the portion of the neutron count from the burst gamma ray count to estimate the net inelastic gamma ray count.

A tenth embodiment may include the ninth embodiment, wherein the function is a logarithmic function or a polynomial function.

In an eleventh embodiment a nuclear logging tool comprises: a pulsed neutron generator (PNG) deployed in a logging tool body; a gamma ray detector deployed in the logging tool body; a neutron detector deployed in the logging tool body; and an electronic controller deployed in the logging tool body, the electronic controller including a processor including instructions configured to: cause the PNG to emit neutrons in a series of burst intervals separated by corresponding capture intervals; cause the gamma ray detector to acquire a burst gamma ray count during the burst intervals; cause the gamma ray detector to acquire a capture gamma ray count during at least one of the capture intervals; cause the neutron detector to acquire a neutron count during at least the burst intervals; and subtract a portion of the capture gamma ray count and a portion of the neutron count from the burst gamma ray count to estimate a net inelastic gamma ray count.

A twelfth embodiment may include the eleventh embodiment, wherein the instructions are configured to cause the neutron detector to acquire the neutron count during both the burst intervals and the capture intervals.

A thirteenth embodiment may include any one of the eleventh through the twelfth embodiments, wherein the subtracting further comprises: multiplying the capture gamma ray count by a first coefficient to compute the portion of the capture gamma ray count; multiplying the neutron count by a second coefficient to compute the portion of the neutron count; and subtracting the portion of the capture gamma ray count and the portion of the neutron count from the burst gamma ray count to estimate the net inelastic gamma ray count.

A fourteenth embodiment may include any one of the eleventh through the thirteenth embodiments, wherein the subtracting further comprises: multiplying the capture gamma ray count by a first coefficient to compute the portion of the capture gamma ray count; processing the neutron count with a function to compute the portion of the neutron count; and subtracting the portion of the capture gamma ray count and the portion of the neutron count from the burst gamma ray count to estimate the net inelastic gamma ray count.

A fifteenth embodiment may include the fourteenth embodiment, wherein the function is a logarithmic function or a polynomial function.

In a sixteenth embodiment a method for estimating a net inelastic gamma ray count comprises: causing a pulsed neutron generator to emit neutrons in a wellbore, the neutrons emitted in a series of burst intervals interspersed with corresponding capture intervals; causing a gamma ray detector to acquire a burst gamma ray count during a plurality of the burst intervals; causing the gamma ray detector to acquire a capture gamma ray count during a plurality of the capture intervals; causing a neutron detector to acquire a neutron count during at least the plurality of burst intervals; processing a function of the neutron count to compute a functional neutron quantity; and subtracting a portion of the capture gamma ray count and the functional neutron quantity from the burst gamma ray count to estimate the net inelastic gamma ray count.

A seventeenth embodiment may include the sixteenth embodiment, wherein the function is a logarithmic function or a polynomial function.

An eighteenth embodiment may include any one of the sixteenth through the seventeenth embodiments, wherein: the causing the gamma ray detector to acquire the capture gamma ray count comprises causing the gamma ray detector to acquire a gamma ray count during a plurality of early capture intervals and a capture gamma ray count during a plurality of late capture intervals, wherein each of the plurality of late capture intervals follows a corresponding one of the plurality of early capture intervals in time; and the subtracting comprises subtracting a portion of the early capture gamma ray count, a portion of the late capture gamma ray count, and the functional neutron quantity from the burst gamma ray count to estimate the net inelastic gamma ray count.

A nineteenth embodiment may include any one of the sixteenth through the eighteenth embodiments, wherein the burst gamma ray count comprises a burst gamma ray count rate; the capture gamma ray count comprises a capture gamma ray count rate; and the neutron count comprises a neutron count rate.

A twentieth embodiment may include any one of the sixteenth through the nineteenth embodiments, further comprising processing the net inelastic gamma ray count to estimate a density of a formation penetrated by the wellbore.

Although estimating net inelastic gamma ray counts has been described in detail, it should be understood that various changes, substitutions and alternations can be made herein without departing from the spirit and scope of the disclosure as defined by the appended claims.

What is claimed is:

1. A method for estimating a net inelastic gamma ray count, the method comprising:
acquiring a burst gamma ray count measured during a neutron burst time interval;
acquiring a capture gamma ray count measured during at least one neutron capture time interval;
acquiring a neutron count during at least the neutron burst time interval; and
subtracting a portion of the capture gamma ray count and a portion of the neutron count from the burst gamma ray count to estimate the net inelastic gamma ray count.

2. The method of claim 1, further comprising:
deploying a logging tool in a subterranean wellbore, the logging tool including a pulsed neutron generator (PNG), a gamma ray detector, and a neutron detector; and
causing the PNG to emit neutrons into the subterranean wellbore during the neutron burst time interval.

3. The method of claim 2, wherein:
the acquiring the burst gamma ray count comprises causing the gamma ray detector to accumulate gamma rays during the neutron burst time interval;
the acquiring the capture gamma ray count comprises causing the gamma ray detector to accumulate gamma rays during the at least one neutron capture time interval; and
the acquiring the neutron count comprises causing the neutron detector to accumulate neutrons during at least the neutron burst time interval.

4. The method of claim 3, wherein the acquiring the neutron count comprises causing the neutron detector to accumulate neutrons during both the neutron burst time interval and one or more of the at least one neutron capture time interval.

5. The method of claim 1, wherein:
the acquired burst gamma ray count comprises a burst gamma ray count rate;
the acquired capture gamma ray count comprises a capture gamma ray count rate; and
the acquired neutron count comprises a neutron count rate.

6. The method of claim 1, wherein:
the acquiring the burst gamma ray count comprises acquiring the burst gamma ray count during a plurality of neutron burst time intervals;
the acquiring the capture gamma ray count comprises acquiring the capture gamma ray count during a plurality of neutron capture time intervals; and the acquiring the neutron count comprises acquiring the neutron count during the plurality of neutron burst intervals and the plurality of neutron capture intervals.

7. The method of claim 1, wherein the acquired neutron count comprises at least thermal neutrons.

8. The method of claim 1, wherein the subtracting further comprises:
multiplying the capture gamma ray count by a first coefficient to compute the portion of the capture gamma ray count;
multiplying the neutron count by a second coefficient to compute the portion of the neutron count; and
subtracting the portion of the capture gamma ray count and the portion of the neutron count from the burst gamma ray count to estimate the net inelastic gamma ray count.

9. The method of claim 1, wherein the subtracting further comprises:
multiplying the capture gamma ray count by a first coefficient to compute the portion of the capture gamma ray count;
processing the neutron count with a function to compute the portion of the neutron count; and
subtracting the portion of the capture gamma ray count and the portion of the neutron count from the burst gamma ray count to estimate the net inelastic gamma ray count.

10. The method of claim 9, wherein the function is a logarithmic function or a polynomial function.

11. A nuclear logging tool comprising:
a pulsed neutron generator (PNG) deployed in a logging tool body;
a gamma ray detector deployed in the logging tool body;
a neutron detector deployed in the logging tool body; and
an electronic controller deployed in the logging tool body, the electronic controller including a processor including instructions configured to:
cause the PNG to emit neutrons in a series of burst intervals separated by corresponding capture intervals;
cause the gamma ray detector to acquire a burst gamma ray count during the burst intervals;
cause the gamma ray detector to acquire a capture gamma ray count during at least one of the capture intervals;
cause the neutron detector to acquire a neutron count during at least the burst intervals; and
subtract a portion of the capture gamma ray count and a portion of the neutron count from the burst gamma ray count to estimate a net inelastic gamma ray count.

12. The nuclear logging tool of claim 11, wherein the instructions are configured to cause the neutron detector to acquire the neutron count during both the burst intervals and the capture intervals.

13. The nuclear logging tool of claim 11, wherein the subtracting further comprises:
multiplying the capture gamma ray count by a first coefficient to compute the portion of the capture gamma ray count;
multiplying the neutron count by a second coefficient to compute the portion of the neutron count; and
subtracting the portion of the capture gamma ray count and the portion of the neutron count from the burst gamma ray count to estimate the net inelastic gamma ray count.

14. The nuclear logging tool of claim 11, wherein the subtracting further comprises:
multiplying the capture gamma ray count by a first coefficient to compute the portion of the capture gamma ray count;
processing the neutron count with a function to compute the portion of the neutron count; and
subtracting the portion of the capture gamma ray count and the portion of the neutron count from the burst gamma ray count to estimate the net inelastic gamma ray count.

15. The nuclear logging tool of claim 14, wherein the function is a logarithmic function or a polynomial function.

16. A method for estimating a net inelastic gamma ray count, the method comprising:
causing a pulsed neutron generator to emit neutrons in a wellbore, the neutrons emitted in a series of burst intervals interspersed with corresponding capture intervals;
causing a gamma ray detector to acquire a burst gamma ray count during a plurality of the burst intervals;
causing the gamma ray detector to acquire a capture gamma ray count during a plurality of the capture intervals;
causing a neutron detector to acquire a neutron count during at least the plurality of burst intervals;
processing a function of the neutron count to compute a functional neutron quantity; and
subtracting a portion of the capture gamma ray count and the functional neutron quantity from the burst gamma ray count to estimate the net inelastic gamma ray count. 28

17. The method of claim 16, wherein the function is a logarithmic function or a polynomial function.

18. The method of claim 16, wherein:
the causing the gamma ray detector to acquire the capture gamma ray count comprises causing the gamma ray detector to acquire a gamma ray count during a plurality of early capture intervals and a capture gamma ray count during a plurality of late capture intervals, wherein each of the plurality of late capture intervals follows a corresponding one of the plurality of early capture intervals in time; and
the subtracting comprises subtracting a portion of the early capture gamma ray count, a portion of the late capture gamma ray count, and the functional neutron quantity from the burst gamma ray count to estimate the net inelastic gamma ray count.

19. The method of claim 16, wherein the burst gamma ray count comprises a burst gamma ray count rate;
the capture gamma ray count comprises a capture gamma ray count rate; and
the neutron count comprises a neutron count rate.

20. The method of claim 16, further comprising processing the net inelastic gamma ray count to estimate a density of a formation penetrated by the wellbore.
